(19) United States
(12) Patent Application Publication
(10) Pub. No.: US 2013/0111959 A1
(43) Pub. Date: May 9, 2013

(54) PRESSURE ACTIVATED RE-LOCKER WITH INTEGRAL REINFORCEMENT FOR A SAFE LOCKING SYSTEM

(71) Applicant: Terrance Pratt, Fresno, CA (US)

(72) Inventor: Terrance Pratt, Fresno, CA (US)

(21) Appl. No.: 13/292,928

(22) Filed: Nov. 9, 2011

(51) Int. Cl. E05B 63/00; E05B 37/00

(52) U.S. Cl. 70/320; 70/333 R

(57) ABSTRACT

A re-locker for safes supports the tongue of the combination box against pressure from the striker by way of a tongue reinforcement. The re-locker of the present invention may only engage when the combination box and/or combination box tongue are actually under attack, thereby reducing or eliminating the chance of an accidental engagement of the re-locker. Once the pressure activated re-locker is engaged, it may not be easily disengaged. The re-locker of the present invention does not require the springs or glass components typical of conventional re-lock designs.

### BACKGROUND OF THE INVENTION

The present invention relates to safes, more particularly to a pressure activated re-locker with integral reinforcement for a safe locking system.

Spring loaded re-lockers are susceptible to firing upon minor attacks, often with one strike of the dial. This can cause the typical spring loaded re-locker to fire during hard usage, when no actual attempt to break in is being made, requiring a locksmith to enter and repair the safe. Spring loaded re-lockers are also typically easy to circumvent, and once fired, are easily disengaged. Additionally, in conventional safe designs, the combination box itself is often weaker than the tongue deadbolt attached to it. No re-locker can function if it is no longer attached to the safe.

As can be seen, there is a need for pressure activated re-locker and tongue reinforcement will only fire when the combination box is actually under attack, and remain attached to the safe in the event the attack persists.

### SUMMARY OF THE INVENTION

In one aspect of the present invention, a re-locker for a safe, comprises a combination box mount; a relock notch formed in the combination box mount; and a tongue reinforcement attached to the combination box mount oriented to brace a combination box tongue on at least two sides.

In another aspect of the present invention, a pressure activated re-locker comprises a combination box mount; a relock notch formed into the combination box mount; a tongue reinforcement attached to the combination box mount oriented to brace a combination box tongue on at least two sides; and an offset supplemental reinforcement attached to the combination box mount and disposed adjacent to the relock notch and a striker.

In a further aspect of the present invention, a method for re-locking a safe comprises attaching a combination box mount to the safe and securing a tongue reinforcement to the combination box mount so that an attack on any portion of a combination box assembly causes a tongue to press against the tongue reinforcement, deflecting both the combination box and the combination box mount simultaneously, causing a relock notch to engage a striker on a safe.

These and other features, aspects and advantages of the present invention will become better understood with reference to the following drawings, description and claims.

### BRIEF DESCRIPTION OF THE DRAWINGS

FIG. 1 is a perspective view of a pressure activated re-locker without a hardplate or combination box installed, according to an exemplary embodiment of the present invention;

FIG. 2 is a front view of the pressure activated re-locker of FIG. 1;

FIG. 3 is a bottom view of the pressure activated re-locker of FIG. 1;

FIG. 4 is a perspective view of the pressure activated re-locker with a hardplate and combination box installed, according to an exemplary embodiment of the present invention;

FIG. 5 is a front view of the pressure activated re-locker of FIG. 4; and

FIG. 6 is a bottom view of the pressure activated re-locker of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a re-locker for safes that supports the tongue of the combination box against pressure from the striker by way of a tongue reinforcement. The re-locker of the present invention may only engage when the combination box and/or combination box tongue are actually under attack, thereby reducing or eliminating the chance of an accidental engagement of the re-locker. Once the pressure activated re-locker is engaged, it may not be easily disengaged. The re-locker of the present invention does not require the springs or glass components typical of conventional re-lock designs. Once engaged, the following steps must be performed to disengage the re-locker of the present invention: 1) a hole of sufficient size to facilitate thread tapping must be bored through the door skin, hard plate, and combination box mount of the safe. 2) The resultant hole in the door skin and hard plate must be enlarged to provide clearance for the selected tapping device. 3) The hole bored in the combination box mount must be tapped. 4) A bolt with matching threads must be installed, providing a hold with which to retract the previously engaged re-locker. The preceding steps are much more time consuming and difficult than methods required to disengage a spring loaded re-locker.

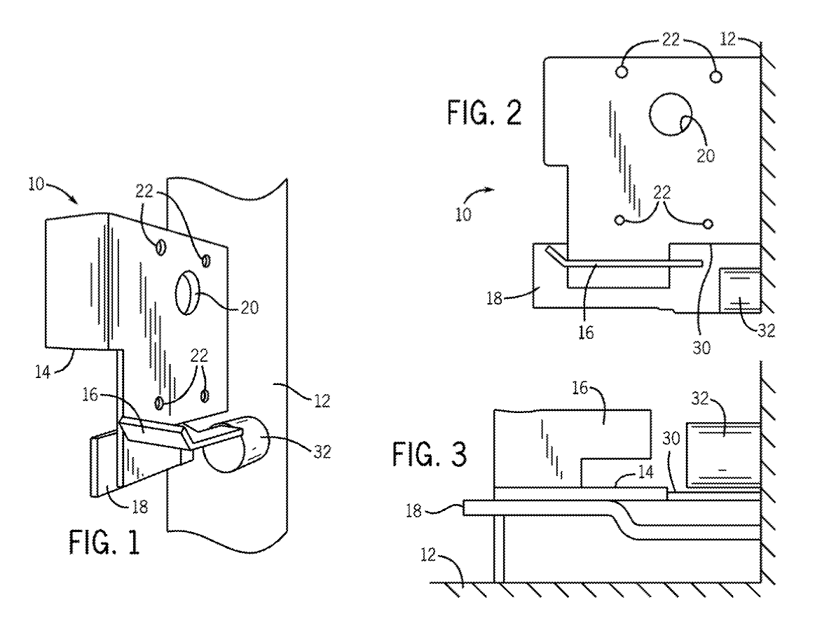

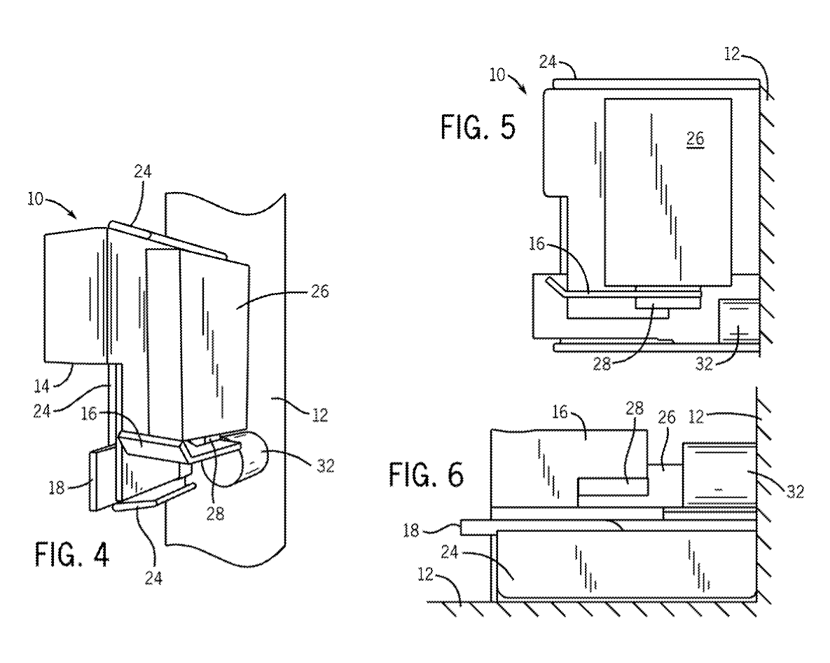

Referring now to FIGS. 1 through 6, a re-locker 10 may be used to provide a re-lock mechanism for a safe striker 12, for example, the re-locker 10 may include a combination box mount 14 that includes a tongue reinforcement 16 attached thereto. The combination box mount 14 may include a notch 30 formed or cut into it intended to act as a re-lock by engaging a striker 32 when a combination box 26 and/or a combination box tongue 28 is attacked. The tongue reinforcement 16 may reinforce the tongue 28 of the combination box 26 by extending around two sides of the tongue 28. The tongue reinforcement 16 may be attached to the combination box mount 14 in a fashion that may capture the tongue 28 and reinforce it from two different directions of possible force.

The combination box mount 14 may further include a clearance hole 20 for the combination box 26 and mounting holes 22 for attaching the combination box 26 to the combination box mount 14.

An offset reinforcement 18 may be mounted under the combination box mount 14 at the location of the re-lock notch 30. The offset reinforcement 18 may strengthen the re-locker 10 and prevent overbending of the combination box mount 14. If the combination box mount 14 is under attack from the front, as by striking the dial and/or the dial shaft, it may deflect away from the door skin, engaging the re-lock notch 30. The offset reinforcement 18 may prevent the re-lock notch 30 from passing beyond the striker 32 and preventing re-lock engagement. If the combination box tongue 28 is under attack as by a punch or shaft inserted through holes bored in the door skin, hard plate 24, and offset reinforcement 18, the tongue reinforcement 16 may transfer force to the combination box mount 14, causing a torsional deflection, engaging the re-lock notch 30. If the combination box tongue 28 is under attack from the side, as by driving the striker 32 against the combination box tongue 28, the tongue reinforcement 16 may allow transfer of force to the combination box mount 14, causing a torsional deflection, engaging the re-lock notch 30. If any frontal attack methods persist to the point of driving the re-lock notch 30 beyond the striker 32, the offset reinforcement 18 may become wrapped around the striker 32, generating additional security. As can be seen, as more force is applied, additional security is provided.

Materials used in the manufacture of the present invention may be conventional, such as steel of various thicknesses and alloys, in addition to any commercially available polymers. The re-locker design illustrated in FIGS. 1 through 6 may be changed within the scope of the present invention. For example, the re-lock notch 30 may be slightly relocated, enlarged, or its proportions altered; the combination box tongue 28 may be made longer or shorter; the thickness of any or all components may be revised or altered, and glass re-lockers and/or spring loaded re-lockers may be added.

It should be understood, of course, that the foregoing relates to exemplary embodiments of the invention and that modifications may be made without departing from the spirit and scope of the invention as set forth in the following claims.

What is claimed is:

1. A re-locker for a safe, comprising:
a combination box mount;
a re-lock notch formed in the combination box mount; and
a tongue reinforcement attached to the combination box mount, the tongue reinforcement oriented to brace a combination box tongue on at least two sides thereof.

2. The re-locker of claim 1, further comprising an offset reinforcement attached to the combination box mount, the offset reinforcement disposed adjacent to the re-lock notch.

3. The re-locker of claim 1, further comprising a hard plate disposed adjacent to the combination box mount.

4. The re-locker of claim 3, further comprising a combination box attached to the combination box mount.

5. The re-locker of claim 1, wherein the tongue reinforcement is welded to the combination box mount.

6. The re-locker of claim 2, wherein the offset reinforcement is welded to the combination box mount.

7. A pressure activated re-locker comprising:
a combination box mount;
a re-lock notch formed in the combination box mount;
a tongue reinforcement attached to the combination box mount, the tongue reinforcement oriented to brace a combination box tongue on at least two sides thereof; and
an offset reinforcement attached to the combination box mount, the offset supplemental attached to the combination box mount and disposed adjacent to the re-lock notch and a striker.

8. The re-locker of claim 7, further comprising:
a hard plate disposed adjacent to the combination box mount; and
a combination box attached to the combination box mount.

9. A method for re-locking a safe, comprising:
attaching a combination box mount to the safe; and
securing a tongue reinforcement to the combination box mount so that an attack on any portion of a combination box assembly causes a tongue to press against the tongue reinforcement, deflecting both the combination box and the combination box mount simultaneously, causing a relock notch to engage a striker on a safe.

10. The method of claim 9, further comprising disposing an offset reinforcement underneath the combination box mount such that when further force is applied to the combination box, so as to move the re-lock notch beyond the striker, the offset reinforcement wraps itself over the top of the striker to further secure the safe.
